(19) United States
(12) Patent Application Publication
(10) Pub. No.: US 2004/0044106 A1
(43) Pub. Date: Mar. 4, 2004

(54) Polypropylene for precision injection molding applications

(76) Inventors: Robert C. Portnoy, Houston, TX (US); Rajan K. Chudgar, League City, TX (US)

Correspondence Address: ExxonMobil Chemical Company, Law Technology, PO Box 2149, Baytown, TX, 77522-2149, US

(21) Appl. No.: 10/432,170

(22) PCT Filed: Nov. 8, 2001
(86) PCT No.: PCT/US01/46883

(51) Int. Cl. C08K 5/51; C08K 5/05

(52) U.S. Cl. 524/136; 524/387

(57) ABSTRACT

The present invention is a nucleated, metallocene catalyzed polypropylene homopolymer with an MFR less than 100 g/10 min, or desirably less than 21 g/10 min, the polypropylene useful in making casting cups and other such articles where a high degree of precision and accuracy in the casting is desirable, such as in contact lens casting cups.

### FIELD OF INVENTION

The present invention relates to an improved polypropylene suitable for use in precision injection molding applications, such as contact lens casting cups, and more particularly metallocene catalyzed polypropylene that is suitable for use in precision injection molding applications such as contact lens casting cups.

### BACKGROUND OF THE INVENTION

Polypropylene has been used for several years for casting cups and molds, wherein a high degree of precision and accuracy in the article to be molded within the cup is desired. Such is the case with, for example, contact lens casting cups, as in U.S. Pat. No. 5,843,346. Use of the casting cups entails placing a liquid methacrylate type of monomer in the interstice between the two halves of the polypropylene cup and polymerized to cast the contact lenses.

Rigid, gas permeable contact lenses and bifocal contact lenses are a specific example of articles that require a very high degree of precision and accuracy in manufacturing. Standards issued by the American National Standards Institute (ANSI Standards Z80.2-1989) define stricter tolerances (diameter, base curve, center thickness, and refractive power) for the rigid contact lenses.

While polypropylene has been used for casting cups, there is a need for an economical polypropylene with more desirable physical properties that would improve the exacting tolerances desired in making such articles as rigid contact lenses. Some related polypropylenes are disclosed in WO 00/25916; EP 0 992516 A2, 0 588 208 A2, 0 576 970 A1; and U.S. Pat. Nos. 6,153,715, 5,972,251, 5,597,881, 5,145,819. In particular, what is needed that has not been provided in the prior art are articles made from polypropylene having a melt flow rate suitable for injection molding, while maintaining a high degree of crystallinity (isotacticity), a rapid rate of crystallization, and a narrow molecular weight distribution, is desirable for such applications. Embodiments of the present invention are directed towards such an improvement.

### SUMMARY OF THE INVENTION

It has been discovered that articles made from polypropylene having a melt flow rate (MFR) at any level suitable for injection molding can be useful for precision applications when the appropriate nucleating agent is included with the polypropylene. In one embodiment, the MFR is a suitable level for injection molding, less than 100 g/10 min in one embodiment, less than 60 g/10 min in another embodiment, and less than 35 g/10 min in yet another embodiment. In one desirable embodiment, the MFR is less than 21 g/10 min, wherein the polymer desirably possesses high degree of crystallinity, and thus suitable for use in precision injection molding applications. More particularly, metallocene catalyzed polypropylenes having a relatively low MFR and desirably high degree of crystallinity are suitable for applications such as contact lens casting cups.

Embodiments of the present invention include high-precision articles such as casting cups, the articles comprising isotactic polypropylene, the polypropylene having a MFR less than 35 g/10 min in one embodiment, and less than 21 g/10 min in another embodiment, and a Mw/Mn value of from 1.5 to 2.5. In one embodiment, the polypropylene also has a melting point of from 149° C. to 159° C. in one embodiment, and a crystallization temperature from 119° C. to 126° C. In another desirable embodiment, the MFR of the polypropylene is from 12 to 19 g/10 min, and from 13 to 17 g/10 min in yet another embodiment. Typically, a nucleating agent is added to the resultant polypropylene during pelletization. Other additives including a primary antioxidant, a secondary antioxidant and an acid scavenger can also be added to the polypropylene.

Embodiments of the invention also include a method of manufacturing a casting cup comprising polymerizing propylene in the presence of a metallocene catalyst system, wherein the resultant, pelletized, polypropylene has a MFR of less than 21 g/10 min. Additives and nucleating agents may also be added in certain embodiments. The use of the metallocene catalyst system at the desirable reaction conditions, along with the addition of a nucleating agent, afford a polypropylene having a rapid rate of crystallization, high degree of crystallinity and a narrow molecular weight distribution. The metallocene catalyst system can be employed in such a fashion as to produce a polypropylene with a low MFR. The polypropylene having the desired MFR is typically injection molded to form the various articles. Specifically for lens casting cups, the anterior and posterior mold sections for lens casting cups are injection molded using embodiments of the polypropylene described below.

### DETAILED DESCRIPTION OF THE INVENTION

It has been discovered that nucleated, metallocene-catalyzed polypropylene with melt flow rates (MFR) lower than 100 g/10 min, desirably lower than 21 g/10 min, and include a nucleating agent, have properties which make them useful for precision applications such as casting cups for the molding of polymerizable-articles. One such example of a polymerizable article requiring a high degree of precision is contact lens casting cups.

Polypropylene formulations suitable for the improved polypropylene formulation contain a nucleating agent, and optionally other additives, the polymer being made from a metallocene catalyst system (described in more detail below). The reaction conditions are adjusted such that the final MFR is at any level suitable for injection molding applications, for example, equal to or less than 100 g/10 min. More particularly, the dual reactor slurry polymerization process is characterized by a temperature differential between the first and second reactors. The reactor temperatures can be controlled in such a manner as to achieve a desirable MFR level. Further, polypropylenes made from the metallocene system are characterized by having a narrow molecular weight distribution (Mw/Mn). Addition of the nucleating agent achieves a desirable level of crystallinity in the polypropylene. Descriptions throughout the specification refer to prospective examples of various embodiments of the invention.

Methods

The methods described herein produce a highly isotactic polypropylene. As used herein, the term “polypropylene” refers to a homopolymer or copolymer of propylene-derived units and at least one other ethylene and/or C₄ to C₁₀ α-olefin-derived unit from 0.1 to 5 wt %. More specifically, these methods produce propylene reaction products having lower MFRs and increased molecular weights in comparison to propylene reaction product polymerized under similar conditions. This is achieved in one embodiment of the invention in a two-stage slurry polymerization system having a desirably low reaction temperature and a desirable temperature differential between the stages. However, the polymer described herein may be made in a one stage or multiple stage gas, slurry, bulk, continuous, solution, or any combination thereof, phase polymerization process.

More particularly, a method of forming a propylene polymer having a MFR suitable for injection molding is provided which includes contacting a metallocene catalyst system under suitable polymerization conditions with polymerizable reactants, such as propylene monomers, and recovering the propylene polymer. In one embodiment, the metallocene catalyst may be a zirconium metallocene catalyst. Additionally, the contacting step may include hydrogen. The hydrogen (in parts per million (ppm)) may be present in the range of 100 to 50,000, and desirably from 500 to 20,000 and most desirably from 1,000 to 10,000 as measured as the gas phase concentration in equilibrium with liquid propylene at polymerization temperature. The polymerizable reactants may be present in the range of 90 to 99.999 wt % and desirably from 93 to 99.997 wt % and more desirably from 95 to 99.995 wt %.

The polymer may desirably be prepared by slurry polymerization of the olefin under conditions in which the catalyst site remains relatively insoluble and/or immobile so that the polymer chains are rapidly immobilized following their formation. Such immobilization is affected, for example, by (1) using a solid, insoluble catalyst, (2) conducting the copolymerization in a medium in which the resulting copolymer is generally insoluble, and (3) maintaining the polymerization reactants and products below the crystalline melting point of the polymer.

Generally, the metallocene or metallocene supported catalyst compositions described below, and in greater detail in the Examples, are desirable for polymerizing olefins. The polymerization processes suitable for polymerizing olefins, and particularly α-olefins, are well known by those skilled in the art and include solution polymerization, slurry polymerization, and low pressure gas phase polymerization. Metallocene supported catalysts compositions are particularly useful in the known operating modes employing fixed-bed, moving-bed, fluid-bed, or slurry processes conducted in single, series or parallel reactors.

Generally, any of the above polymerization process may be used. When propylene is the selected olefin, a common propylene polymerization process is one that is conducted using a two-stage slurry process in which the polymerization medium can be either a liquid monomer, like propylene, or a hydrocarbon solvent or diluent, advantageously aliphatic paraffin such as propane, isobutane, hexane, heptane, cyclohexane, etc. or an aromatic diluent such as toluene. In this instance, the polymerization temperatures may be those considered low, for example, less than 50° C., desirably from 0° C. to 30° C., or may be in a higher range, such as up to about 150° C., desirably from 50° C. up to about 80° C., or at any ranges between the end points indicated. Pressures can vary from about 100 to about 700 psia (0.69-4.8 MPa). Additional description is given in U.S. Pat Nos. 5,274,056 and 4,182,810; and WO 94/21962.

Pre-polymerization may also be used for further control of polymer particle morphology in typical slurry or gas phase reaction processes in accordance with conventional teachings. For example, this can be accomplished by pre-polymerizing a C₂-C₆ α-olefin, for a limited time. The pre-polymerized catalyst is then available for use in the polymerization processes referred to above. In a similar manner, the activated catalyst on a support coated with a previously polymerized polymer can be utilized in these polymerization processes.

Additionally, it is desirable to reduce or eliminate polymerization poisons that may be introduced via feedstreams, solvents or diluents, by removing or neutralizing the poisons. For example, monomer feed streams or the reaction diluent may be pre-treated, or treated in situ during the polymerization reaction, with a suitable scavenging agent. Typically such will be an organometallic compound employed in processes such as those using the Group-13 organometallic compounds described in U.S. Pat. No. 5,153,157; and WO-A-91/09882 and WO-A-94/03506, noted above, and that of WO-A-93/14132.

Catalyst System

As used herein “metallocene” refers generally to compounds represented by the formula CpₘMRₙX_{q} wherein Cp is a cyclopentadienyl ring which may be substituted, or derivative thereof which may be substituted, M is a Group 4, 5, or 6 transition metal, for example titanium, zirconium, hafnium, vanadium, niobium, tantalum, chromium, molybdenum and tungsten, R is a hydrocarbyl group or hydrocarboxy group having from one to 20 carbon atoms, X is a halogen, and m=1-3, n=0-3, q=0-3, and the sum of m+n+q is equal to the oxidation state of the transition metal. The “catalyst system” includes the at least one metallocene, and any activators or other compounds useful in the polymerization of olefins.

Methods for making and using metallocenes are very well known in the art. For example, metallocenes are detailed in U.S. Pat Nos. 4,530,914; 4,542,199; 4,769,910; 4,808,561; 4,871,705; 4,933,403; 4,937,299; 5,017,714; 5,026,798; 5,057,475; 5,120,867; 5,278,119; 5,304,614; 5,324,800; 5,350,723; and 5,391,790.

Metallocenes useful in embodiments of the invention are those represented by the formula:

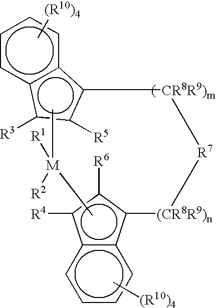

wherein M is a metal of Group 4, 5, or 6 of the Periodic Table, and are zirconium, hafnium and titanium in one embodiment, and zirconium in another embodiment.

R¹ and R² are identical or different, desirably identical, and are one of the following: a hydrogen atom, a C₁-C₁₀ alkyl group, a C₁-C₃ alkyl group in another embodiment; a C₁-C₁₀ alkoxy group, a C₁-C₃ alkoxy group in another embodiment; a C₆-C₁₀ aryl group, a C₆-C₈ aryl group in another embodiment; a C₆-C₁₀ aryloxy group, a C₆-C₈ aryloxy group in another embodiment; a C₂-C₁₀ alkenyl group, a C₂-C₄ alkenyl group in another embodiment; a C₇-C₄₀ arylalkyl group, a C₇-C₁₀ arylalkyl group in another embodiment; a C₇-C₄₀ alkylaryl group, a C₇-C₁₂ alkylaryl group in another embodiment; a C₈-C₄₀ arylalkenyl group, a C₈-C₁₂ arylalkenyl group in another embodiment; or a halogen atom, desirably chlorine.

R³ and R⁴ are hydrogen atoms.

R⁵ and R⁶ are identical or different, desirably identical, and are one of the following: a halogen atom, or a fluorine, chlorine or bromine atom in another embodiment; a C₁-C₁₀ alkyl group, or a C₁-C₄ alkyl group in another embodiment, any of which may be halogenated; a C₆-C₁₀ aryl group, which may be halogenated, or a C₆-C₈ aryl group in another embodiment, which may be halogenated; a C₂-C₁₀ alkenyl group, or a C₂-C₄ alkenyl group in another embodiment; a C₇-C₄₀-arylalkyl group, or a C₇-C₁₀ arylalkyl group in another embodiment; a C₇-C₄₀ alkylaryl group, or a C₇-C₁₂ alkylaryl group in another embodiment; a C₈-C₄₀ arylalkenyl group, or a C₈-C₁₂ arylalkenyl group in another embodiment; or a —NR₂¹⁵, —SR¹⁵, —OR¹⁵, —OSiR₃¹⁵ or —PR₂¹⁵ radical. R¹⁵ is one of a halogen atom, a chlorine atom in one embodiment; a C₁-C₁₀ alkyl group, a C₁-C₃ alkyl group in another embodiment; a C₆-C₁₀ aryl group, or a C₆-C₉ aryl group in another embodiment.

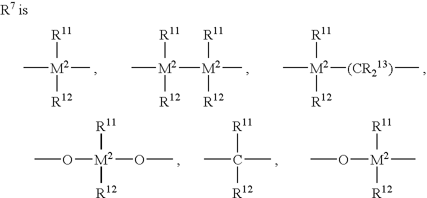

—B(R¹¹)—, —Al(R¹¹)—, —Ge—, —Sn—, —O—, —S—, —SO—, —SO₂—, —N(R¹¹)—, —CO—, —P(R¹¹)—, or —P(O)(R¹¹)—.

Further, R¹¹, R¹² and R¹³ are identical or different and are a hydrogen atom, a halogen atom, or a C₁-C₂₀ alkyl group. In certain embodiments, R¹¹, R¹² and R¹³ are a C₁-C₁₀ alkyl group, a C₁-C₂₀ fluoroalkyl group, a C₁-C₁₀ fluoroalkyl group in another embodiment; a C₆-C₃₀ aryl group, a C₆-C₂₀ aryl group in another embodiment; a C₆-C₃₀ fluoroaryl group, a C₆-C₂₀ fluoroaryl group in another embodiment; a C₁-C₂₀ alkoxy group, a C₁-C₁₀ alkoxy group in another embodiment; a C₂-C₂₀ alkenyl group, a C₂-C₁₀ alkenyl group in another embodiment; a C₇-C₄₀ arylalkyl group, a C₇-C₂₀ arylalkyl group in another embodiment; a C₈-C₄₀ arylalkenyl group, a C₈-C₂₂ arylalkenyl group in another embodiment; a C₇-C₄₀ alkylaryl group, a C₇-C₂₀ alkylaryl group in another embodiment, or R¹¹ and R¹², or R¹¹ and R¹³, together with the atoms binding them, can form ring systems.

M² is silicon, germanium or tin, preferably silicon or germanium, most preferably silicon.

R⁸ and R⁹ are identical or different and have the meanings stated for R¹¹.

The values of m and n are identical or different and are zero, 1 or 2, desirably zero or 1, m plus n being zero, 1 or 2, desirably zero or 1; and the radical R¹⁰ are identical or different and have the meanings stated for R¹¹, R¹² and R¹³. More particularly, R¹⁰ radicals can be form a ring system, desirably a ring system containing from about 4-6 carbon atoms, and can be an aromatic ring.

Alkyl refers to straight or branched chain substituents. Halogen (halogenated) refers to fluorine, chlorine, bromine or iodine atoms, desirably fluorine or chlorine.

Metallocenes in yet another embodiment that are useful are compounds of the structures (A) and (B):

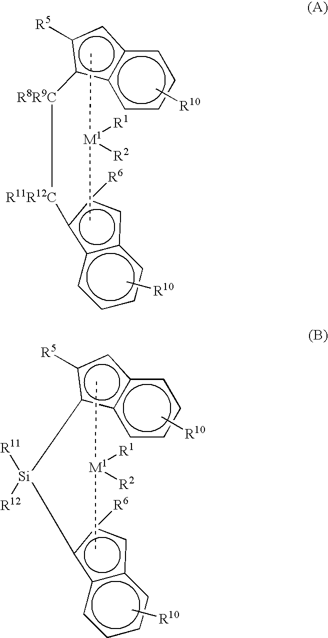

wherein M¹ is Zr or Hf, R¹ and R² are methyl or chlorine, and R⁵, R⁶, R⁸, R⁹, R¹⁰, R¹¹ and R¹² have the above-mentioned meanings.

These chiral metallocenes may be used as a racemic mixture for the preparation of highly isotactic polypropylene copolymers. It is also possible to use the pure R or S form. An optically active polymer can be prepared with these pure stereoisomeric forms. Desirably, the meso form of the metallocene is removed to ensure the center (i.e., the metal atom) provides stereoregular polymerization. Separation of the stereoisomers can be accomplished by known literature techniques. For special products it is also possible to use rac/meso mixtures.

Additional methods for preparing metallocenes are fully described in the 288 J. ORGANOMETALLIC CHEM. 63-67 (1985), and in EP-A- 320762.

Illustrative but non-limiting examples of preferred metallocenes include:

Dimethylsilandiylbis (2-methyl-4-phenyl-1-indenyl)ZrCl₂

Dimethylsilandiylbis(2-methyl-4,5-benzoindenyl)ZrCl₂;

Dimethylsilandiylbis(2-methyl-4,6-diisopropylindenyl)ZrCl₂;

Dimethylsilandiylbis(2-ethyl-4-phenyl-1-indenyl)ZrCl₂;

Dimethylsilandiylbis (2-ethyl-4-naphthyl-1-indenyl)ZrCl₂,

Phenyl(methyl)silandiylbis(2-methyl-4-phenyl-1-indenyl)ZrCl₂,

Dimethyl silandiylbis(2-methyl-4-(1-naphthyl)-1-indenyl)ZrCl₂,

Dimethylsilandiylbis(2-methyl-4-(2-naphthyl)-1-indenyl)ZrCl₂,

Dimethylsilandiylbis(2-methyl-indenyl)ZrCl₂,

Dimethylsilandiylbis(2-methyl-4,5-diisopropyl-1-indenyl)ZrCl₂,

Dimethylsilandiylbis(2,4,6-trimethyl-1-indenyl)ZrCl₂,

Phenyl(methyl)silandiylbis(2-methyl-4,6-diisopropyl-1-indenyl)ZrCl₂,

1,2-Ethandiylbis(2-methyl-4,6-diisopropyl-1-indenyl)ZrCl₂,

1,2-Butandiylbis(2-methyl-4,6-diisopropyl-1-indenyl)ZrCl₂,

Dimethylsilandiylbis(2-methyl-4-ethyl-1-indenyl)ZrCl₂,

Dimethylsilandiylbis(2-methyl-4-isopropyl-1-indenyl)ZrCl₂,

Dimethylsilandiylbis(2-methyl-4-t-butyl-1-indenyl)ZrCl₂,

Phenyl(methyl)silandiylbis(2-methyl-4-isopropyl-1-indenyl)ZrCl₂,

Dimethylsilandiylbis(2-ethyl-4-methyl-1-indenyl)ZrCl₂,

Dimethylsilandiylbis(2,4-dimethyl-1-indenyl)ZrCl₂,

Dimethylsilandiylbis(2-methyl-4-ethyl-1-indenyl)ZrCl₂,

Dimethylsilandiylbis(2-methyl-α-acenaphth-1-indenyl)ZrCl₂,

Phenyl(methyl)silandiylbis(2-methyl-4,5-benzo-1-indenyl)ZrCl₂,

Phenyl(methyl)silandiylbis(2-methyl-4,5-(methylbenzo)-1-indenyl)ZrCl₂,

Phenyl(methyl)silandiylbis(2-methyl-4,5-(tetramethylbenzo)-1-indenyl)ZrCl₂,

Phenyl(methyl)silandiylbis (2-methyl-α-acenaphth-1-indenyl)ZrCl_{2,}

1,2-Ethandiylbis(2-methyl-4,5-benzo-1-indenyl)ZrCl₂,

1,2-Butandiylbis(2-methyl-4,5-benzo-1-indenyl)ZrCl₂,

Dimethylsilandiylbis(2-methyl-4,5-benzo-1-indenyl)ZrCl₂,

1,2-Ethandiylbis(2,4,7-trimethyl-1-indenyl)ZrCl₂,

Dimethylsilandiylbis(2-methyl-1-indenyl)ZrCl₂,

1,2-Ethandiylbis(2-methyl-1-indenyl)ZrCl₂,

Phenyl(methyl)silandiylbis(2-methyl-1-indenyl)ZrCl₂,

Diphenylsilandiylbis(2-methyl-1-indenyl)ZrCl₂,

1,2-Butandiylbis(2-methyl-1-indenyl)ZrCl₂,

Dimethylsilandiylbis(2-ethyl-1-indenyl)ZrCl₂,

Dimethylsilandiylbis(2-methyl-5-isobutyl-1-indenyl)ZrCl₂,

Phenyl(methyl)silandiylbis(2-methyl-5-isobutyl-1-indenyl)ZrCl₂,

Dimethylsilandiylbis(2-methyl-5-t-butyl-1-indenyl)ZrCl₂,

Dimethylsilandiylbis(2,5,6-trimethyl-1-indenyl)ZrCl₂, and the like.

These preferred metallocene catalyst components are described in detail in U.S. Pat. Nos. 5,145,819; 5,243,001; 5,239,022; 5,329,033; 5,296,434; 5,276,208; and 5,374,752; and EP 549 900 and 576 970.

The metallocenes preferably selected for use in this invention are at least one metallocene catalyst system capable of producing isotactic, crystalline propylene polymer. Thus, in one embodiment at least one metallocene is selected from the group consisting of rac-: dimethylsilandiylbis(2-methylindenyl)zirconium dichloride; dimethylsilandiylbis(2,4-dimethylindenyl)zirconium dichloride; dimethylsilandiylbis(2,5,6-trimethylindenyl)zirconium dichloride; dimethylsilandiylbis indenyl zirconium dichloride; dimethylsilandiylbis(4,5,6,7-tetrahydroindenyl)zirconium dichloride and dimethylsilandiylbis(2-methyl-4,5-benzoindenyl)zirconium dichloride; dimethylsilandiylbis(2-methyl-4-phenylindenyl)zirconium dichloride; dimethylsilandiylbis(2-methyl-4,6-diisopropylindenyl)zirconium dichloride; dimethylsilandiylbis(2-methyl-4-napthylindenyl)zirconium dichloride; and dimethylsilandiylbis(2-ethyl-4-phenylindenyl)zirconium dichloride.

Another suitable class of metallocenes are cyclopentadienyl complexes which have two coordinated ring systems as ligands and either alkyl groups or halides coordinated directly to the metal center. Illustrative but non-limiting examples of preferred substituted, bridged indenyls include:

Dimethylsilandiylbis (2-methyl-4-phenyl-1-indenyl)Zr(CH₃)₂

Dimethylsilandiylbis(2-methyl-4,5-benzoindenyl) Zr(CH₃)₂;

Dimethylsilandiylbis(2-methyl-4,6-diisopropylindenyl) Zr(CH₃)₂;

Dimethylsilandiylbis(2-ethyl-4-phenyl-1-indenyl) Zr(CH₃)₂;

Dimethylsilandiylbis (2-ethyl-4-naphthyl-1-indenyl) Zr(CH₃)₂,

Phenyl(methyl)silandiylbis(2-methyl-4-phenyl-1-indenyl) Zr(CH₃)₂,

Dimethylsilandiylbis(2-methyl-4-(1-naphthyl)-1-indenyl) Zr(CH₃)₂,

Dimethylsilandiylbis(2-methyl-4-(2-naphthyl)-1-indenyl) Zr(CH₃)₂,

Dimethylsilandiylbis(2-methyl-indenyl) Zr(CH₃)₂,

Dimethylsilandiylbis(2-methyl-4,5-diisopropyl-1-indenyl) Zr(CH₃)₂,

Dimethylsilandiylbis(2,4,6-trimethyl-1-indenyl) Zr(CH₃)₂,

Phenyl(methyl)silandiylbis(2-methyl-4,6-diisopropyl-1-indenyl) Zr(CH₃)₂,

1,2-Ethandiylbis(2-methyl-4,6-diisopropyl-1-indenyl) Zr(CH₃)₂,

1,2-Butandiylbis(2-methyl-4,6-diisopropyl-1-indenyl) Zr(CH₃)₂,

Dimethylsilandiylbis(2-methyl-4-ethyl-1-indenyl) Zr(CH₃)₂,

Dimethylsilandiylbis(2-methyl-4-isopropyl-1-indenyl) Zr(CH₃)₂,

Dimethylsilandiylbis(2-methyl-4-t-butyl-1-indenyl) Zr(CH₃)₂,

Phenyl(methyl)silandiylbis(2-methyl-4-isopropyl-1-indenyl) Zr(CH₃)₂,

Dimethylsilandiylbis(2-ethyl-4-methyl-1-indenyl) Zr(CH₃)₂,

Dimethylsilandiylbis(2,4-dimethyl-1-indenyl) Zr(CH₃)₂,

Dimethylsilandiylbis(2-methyl-4-ethyl-1-indenyl) Zr(CH₃)₂,

Dimethylsilandiylbis(2-methyl-α-acenaphth-1-indenyl) Zr(CH₃)₂,

Phenyl(methyl)silandiylbis(2-methyl-4,5-benzo-1-indenyl) Zr(CH₃)₂,

Phenyl(methyl)silandiylbis(2-methyl-4,5-(methylbenzo)-1-indenyl) Zr(CH₃)₂,

Phenyl(methyl)silandiylbis(2-methyl-4,5-(tetramethylbenzo)-1-indenyl) Zr(CH₃)₂,

Phenyl(methyl)silandiylbis (2-methyl-a-acenaphth-1-indenyl) Zr(CH₃)₂,

1,2-Ethandiylbis(2-methyl-4,5-benzo-1-indenyl) Zr(CH₃)₂,

1,2-Butandiylbis(2-methyl-4,5-benzo-1-indenyl) Zr(CH₃)₂,

Dimethylsilandiylbis(2-methyl-4,5-benzo-1-indenyl) Zr(CH₃)₂,

1,2-Ethandiylbis(2,4,7-trimethyl-1-indenyl) Zr(CH₃)₂,

Dimethylsilandiylbis(2-methyl-1-indenyl) Zr(CH₃)₂,

1,2-Ethandiylbis(2-methyl-1-indenyl) Zr(CH₃)₂,

Phenyl(methyl)silandiylbis(2-methyl-1-indenyl) Zr(CH₃)₂,

Diphenylsilandiylbis(2-methyl-1-indenyl) Zr(CH₃)₂,

1,2-Butandiylbis(2-methyl-1-indenyl) Zr(CH₃)₂,

Dimethylsilandiylbis(2-ethyl-1-indenyl) Zr(CH₃)₂,

Dimethylsilandiylbis(2-methyl-5-isobutyl-1-indenyl) Zr(CH₃)₂,

Phenyl(methyl)silandiylbis(2-methyl-5-isobutyl-1-indenyl) Zr(CH₃)₂,

Dimethylsilandiylbis(2-methyl-5-t-butyl-1-indenyl) Zr(CH₃)₂,

Dimethylsilandiylbis(2,5,6-trimethyl-1-indenyl) Zr(CH₃)₂, and the like.

These and other preferred substituted, bridged indenyl compounds are described in detail in U.S. Pat. Nos. 5,145,819; 5,243,001; 5,239,022; 5,329,033; 5,296,434; 5,276,208; 5,672,668, 5,304,614 and 5,374,752; and EP 549 900 and 576 970.

Additionally, metallocenes such as those described in U.S. Pat. Nos. 5,510,502. 4,931,417, 5,532,396, 5,543,373, and WO 98/014585, EP611 773 and WO 98/22486.

The metallocenes described above, in use with the appropriate activator, can achieve molecular weights in the range of 70,000 to 150,000, in one embodiment, and from 70,000 to 280,000 in another embodiment, while the molecular weight distribution is from 1.5 to 2.5. Also, see U.S. Pat. Nos. 5,840,644 and 5,936,053.

Activators

Metallocenes are generally used in combination with some form of activator in order to create an active catalyst system. The term “activator” is defined herein to be any compound or component, or combination of compounds or components, capable of enhancing the ability of one or more metallocenes to polymerize olefins to polyolefins. Alklyalumoxanes are preferably used as activators, most preferably methylalumoxane (MAO). Generally, the alkylalumoxanes preferred for use in olefin polymerization contain about 5 to 40 of the repeating units:

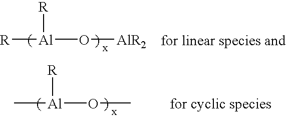

where R is a C₁-C₈ alkyl including mixed alkyls. Particularly preferred are the compounds in which R is methyl. Alumoxane solutions, particularly methylalumoxane solutions, may be obtained from commercial vendors as solutions having various concentrations. There are a variety of methods for preparing alumoxane, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,329,032, 5,416,229, 5,391,793; and EP-B1-0 279 586, EP-B1-0 287 666 and EP-B1-0 406 912. (as used herein unless otherwise stated “solution” refers to any mixture including suspensions).

Some MAO solutions tend to become cloudy and gelatinous over time. It may be advantageous to clarify such solutions prior to use. A number of methods are used to create gel-free MAO solutions or to remove gels from the solutions. Gelled solutions are often simply filtered or decanted to separate the gels from the clear MAO. U.S. Pat. No. 5,157,137, for example, discloses a process for forming clear, gel-free solutions of alkylalumoxane by treating a solution of alkylalumoxane with an anhydrous salt and/or hydride of an alkali or alkaline earth metal.

Ionizing activators may also be used to activate metallocenes. These activators are neutral or ionic, or are compounds such as tri(n-butyl)ammonium tetrakis(pentaflurophenyl)boron, which ionize the neutral metallocene compound. Such ionizing compounds may contain an active proton, or some other cation associated with but not coordinated or only loosely coordinated to the remaining ion of the ionizing compound. Combinations of activators may also be used, for example, alumoxane and ionizing activators in combinations, see for example, EP-B1-0 662 979.

Examples of suitable NCA precursors capable of activating labile non-halogen substituted metallocene compounds via ionic cationization, and consequent stabilization with a resulting non-coordinating anion include:

trialkyl-substituted ammonium salts such as;

trimethylammonium tetrakis(p-tolyl)borate,

trimethylammonium tetrakis(o-tolyl)borate,

tributylammonium tetrakis(pentafluorophenyl)borate,

tripropylammonium tetrakis(o,p-dimethylphenyl)borate,

tributylammonium tetrakis(m,m-dimethylphenyl)borate,

tributylammonium tetrakis(p-trifluoromethylphenyl)borate,

tributylammonium tetrakis(pentafluorophenyl)borate,

tri(n-butyl)ammonium tetrakis(o-tolyl)borate and the like;

N,N-dialkyl anilinium salts such as;

N,N-dimethylanilinium tetrakis(pentafluorophenyl)borate,

N,N-dimethylaniliniumtetrakis(heptafluoronaphthyl)borate,

N,N-dimethylanilinium tetrakis(perfluoro-4-biphenyl)borate and the like;

dialkyl ammonium salts such as;

di-(isopropyl)ammonium tetrakis(pentafluorophenyl)borate and the like;

and triaryl phosphonium salts such as;

triphenylphosphonium tetrafluorophenylborate,

tri(methylphenyl)phosphonium tetraphenylborate,

tri(dimethylphenyl)phosphonium tetraphenylborate and the like.

Further examples of suitable NCA precursors include those comprising a stable carbonium ion, and a compatible non-coordinating anion. These include;

triphenylcarbenium tetrakis (trifluorophenyl) borate

tropillium tetrakis(pentafluorophenyl)borate,

triphenylmethylium tetrakis(pentafluorophenyl)borate,

benzene (diazonium) tetrakis(pentafluorophenyl)borate,

tropillium phenyltris(pentafluorophenyl)borate,

triphenylmethylium phenyl-(trispentafluorophenyl)borate,

benzene (diazonium) phenyl-tris(pentafluorophenyl)borate,

tropillium tetrakis(2,3,5,6-tetrafluorophenyl)borate,

triphenylmethylium tetrakis(2,3,5,6-tetrafluorophenyl)borate,

benzene (diazonium) tetrakis(3,4,5-trifluorophenyl)borate,

tropillium tetrakis(3,4,5-trifluorophenyl)borate,

benzene (diazonium) tetrakis(3,4,5-trifluorophenyl)borate,

tropillium tetrakis(3,4,5-trifluorophenyl)aluminate,

triphenylmethylium tetrakis(3,4,5-trifluorophenyl)aluminate,

benzene (diazonium) tetrakis(3,4,5-trifluorophenyl)aluminate,

tropillinum tetrakis(1,2,2-trifluoroethenyl)borate,

triphenylmethylium tetrakis(1,2,2-trifluoroethenyl)borate,

benzene (diazonium) tetrakis(1,2,2-trifluoroethenyl)borate,

tropillium tetrakis(2,3,4,5-tetrafluorophenyl)borate,

triphenylmethylium tetrakis(2,3,4,5-tetrafluorophenyl)borate,

benzene (diazonium) tetrakis(2,3,4,5-tetrafluorophenyl)borate, and the like.

Descriptions of ionic catalysts for coordination polymerization comprised of metallocene cations activated by non-coordinating anions appear in EP-A-0 277 004, EP-B1-0 672 688, EP-B1-0 551 277 and U.S. Pat. Nos. 5,198,401, 5,278,119, 5,407,884, 5,483,014. These references teach a preferred method of preparation wherein metallocenes (bisCp and monoCp) are protonated by an anion precursor such that an alkyl/hydride group is abstracted from a transition metal to make it both cationic and charge-balanced by the non-coordinating anion.

The term “noncoordinating anion” means an anion which either does not coordinate to said cation or which is only weakly coordinated to said cation thereby remaining sufficiently labile to be displaced by a neutral Lewis base. “Compatible” noncoordinating anions are those which are not degraded to neutrality when the initially formed complex decomposes. Further, the anion will not transfer an anionic substituent or fragment to the cation so as to cause it to form a neutral four coordinate metallocene compound and a neutral by-product from the anion. Noncoordinating anions useful in accordance with this invention are those which are compatible, stabilize the metallocene cation in the sense of balancing its ionic charge in a +1 state, yet retain sufficient lability to permit displacement by an ethylenically or acetylenically unsaturated monomer during polymerization.

The use of ionizing ionic compounds not containing an active proton but capable of producing the both the active metallocene cation and a noncoordinating anion is also known. See, EP-B1-0 426 637 and EP-A3-0 573 403. An additional method of making the ionic catalysts uses ionizing anion pre-cursors which are initially neutral Lewis acids but form the cation and anion upon ionizing reaction with the metallocene compounds, for example the use of tris(pentafluorophenyl) boron. See EP-B1-0 520 732. Ionic catalysts for addition polymerization can also be prepared by oxidation of the metal centers of transition metal compounds by anion pre-cursors containing metallic oxidizing groups along with the anion groups, see EP-B1-0 495 375.

Where the metal ligands include halogen moieties (for example, bis-cyclopentadienyl zirconium dichloride) which are not capable of ionizing abstraction under standard conditions, they can be converted via known alkylation reactions with organometallic compounds such as lithium or aluminum hydrides or alkyls, alkylalumoxanes, Grignard reagents, etc. See EP-A4-0 500 944 and EP-B1-0 570 982 and U.S. Pat. No. 5,434,115, for in situ processes describing the reaction of alkyl aluminum compounds with dihalo-substituted metallocene compounds prior to or with the addition of activating anionic compounds.

The metallocene, activator, or both may be part of a supported catalyst system, wherein the metallocene, activator, or both are supported on an organic or inorganic matrix such as silica, alumina, or other suitable solid support. The support may be pretreated with such reagents as fluoriding agents or other suitable reagents that improve the support surface and increase the catalyst efficiency. Such suitable systems are disclosed in, for example, U.S. Pat. Nos. 6,143,686, 6,228,795, 6,143,911, 5,939,347, and 5,643,847 and WO 00/12565, WO 00/25916. For example, a suitable catalyst composition is a bridged 2-alkyl-4-phenyl-indenyl metallocene and at least one highly fluorinated tris-arylborane bound to a fluorided support composition, wherein the highly fluorinated tris-arylborane is selected from tris-perfluorophenyl borane, trisperfluoronaphthyl borane, trisperfluorobiphenyl borane, tris(3,5-di(trifluoromethyl)phenyl)borane, tris(di-t-butylmethylsilyl)perfluorophenylborane, and mixtures thereof, and the fluorided support composition is selected from fluorided talc, clay, silica, alumina, magnesia, zirconia, iron oxides, boria, calcium oxide, zinc oxide, barium oxide thoria, aluminum phosphate gel, polyvinylchloride or substituted polystyrene, and mixtures thereof.

Polymerization Reaction Conditions

Typically, the metallocene is used in the polymerization in a concentration, based on the transition metal, of from 10⁻³ to 10⁻⁸ mol, in another embodiment from 10⁻⁴ to 10⁻⁷ mol, of transition metal per dm³ of solvent or per dm³ of reactor volume. When alumoxane is used as the cocatalyst, it is used in a concentration of from 10⁻⁵ to 10⁻¹ mol, in another embodiment from 10⁻⁴ to 10⁻² mol, per dm³ of solvent or per dm³ of reactor volume. The other cocatalysts mentioned are used in an approximately equimolar amount with respect to the metallocene. In principle, however, higher concentrations are also possible.

If the polymerization is carried out as a suspension or solution polymerization, an inert solvent which is customary for the Ziegler low-pressure process is typically used for example, the polymerization is carried out in an aliphatic or cycloaliphatic hydrocarbon; examples of which are propane, butane, hexane, heptane, isooctane, cyclohexane and methylcyclohexane. It is also possible to use a benzene or hydrogenated diesel oil fraction. Toluene can also be used. The polymerization is preferably carried out in the liquid monomer. If inert solvents are used, the monomers are metered in gas or liquid form.

Before addition of the catalyst, in particular of the supported catalyst system, another alkylaluminum compound, such as, for example, trimethylaluminum, triethylaluminum, triisobutylaluminum, trioctylaluminum or isoprenylaluminum, may additionally be introduced into the reactor in order to render the polymerization system inert (for example to remove catalyst poisons present in the olefin). This compound is added to the polymerization system in a concentration of from 100 to 0.01 mmol of Al per kg of reactor contents. Preference is given to triisobutylaluminum and triethylaluminum in a concentration of from 10 to 0.1 mmol of Al per kg of reactor contents. This allows the molar Al/M¹ ratio to be selected at a low level in the synthesis of a supported catalyst system.

Molecular Weight and MWD

Techniques for determining the molecular weight (Mn and Mw) and molecular weight distribution (MWD) can be found in U.S. Pat. No. 4,540,753 to Cozewith et al. and references cited therein, and in Verstrate et al., 21 MACROMOLECULES 3360 (1988) and references cited therein.

Melt Flow Rate

Melt Flow Rate (MFR) of the polymers was measured according to ASTM D1238 at 230° C., with a 2.16 kg load.

Thermal Analysis

Crystallization data were determined by differential scanning calorimetry (DSC). The non-isothermal crystallization temperature is recorded as the temperature of greatest heat generation, typically between 100° C. to 125° C. The area under the peak corresponds to the heat of crystallization (Hc).

Additives Embodiments of the polypropylene of the invention contain a nucleating agent, an additive specifically utilized to increase the rate of crystallization of the polymer as it cools from the melt as compared to the same polymer in the absence of such an additive. There are many types of nucleating agents for polypropylene, which would are suitable for inclusion in the polypropylene formulations of this invention. Suitable nucleating agents are disclosed by, for example, H. N. Beck in Heterogeneous Nucleating Agents for Polypropylene Crystallization, 11 J. APPLIED POLY. SCI. 673-685 (1967) and in Heterogeneous Nucleation Studies on Polypropylene, 21 J. POLY. SCI.: POLY. LETTERS 347-351 (1983). Examples of suitable nucleating agents are sodium benzoate, sodium 2,2′-methylenebis(4,6-di-tert-butylphenyl) phosphate, aluminum 2,2′-methylenebis(4,6-di-tert-butylphenyl) phosphate, dibenzylidene sorbitol, di(p-tolylidene) sorbitol, di(p-ethylbenzylidene) sorbitol, bis(3,4-dimethylbenzylidene) sorbitol, and N′,N′-dicyclohexyl-2,6-naphthalenedicarboxamide, and salts of disproportionated rosin esters. The foregoing list is intended to be illustrative of suitable choices of nucleating agents for inclusion in the subject polypropylene formulations, but it is not intended to limit in any way the nucleating agents which may be used.

Other additives may be included in the subject polypropylene formulations as suggested by the intended uses of the materials and the knowledge and experience of the formulator. In one embodiment, included in the polypropylene formulation is a primary antioxidant to deter oxidative degradation of the polymer and an acid scavenger to neutralized acid catalyst residues which may be present in the polymer to a greater or lesser extent. Examples of the former class of additives would be hindered phenolic antioxidants and hindered amine light stabilizers, examples and the application of which are well documented in the art. Examples of the latter category of additives would be metal salts of weak fatty acids such as sodium, calcium, or zinc stearate and weakly basic, naturally occurring minerals such as hydrotalcite or a synthetic equivalent like DHT-4A (Mg_{4.5}Al₂(OH)₁₃CO₃.3.5H₂0, Kiowa Chemical Industry Co., Ltd.). As elsewhere in this specification, these listings of possible additives are meant to be illustrative but not limiting of the choices which may be employ.

In another embodiment, a secondary antioxidant is added to the resultant polypropylene pellets to stabilize the resins to oxidative degradation during high temperature processes to which they might be subjected or during very long storage periods at somewhat elevated temperatures. Representative examples of the former, high temperature stabilizers are organic phosphorous acid esters (phosphites) such as trinonylphenol phosphite and tris(2,4-di-t-butylphenyl) phosphite, and more recently discovered agents such as distearyl, hyroxylamine and 5,7-di-t-butyl-3-(3,4-dimethylphenyl)-3H-benzofuranone. The high temperature stabilizers include distearyl thiodipropionate and other fatty esters of thiodipropionic acid. Other agents of these types, which are too numerous to list here, may likewise be utilized, but the foregoing is a representative, non-limiting list of commonly used examples.

Many other types of additives could be optionally included in the resin formulations of this invention such as lubricants, antistatic agents, slip agents, anti-blocking agents, colorants, metal deactivators, mold release agents, fillers and reinforcements, fluorescent whitening agents, biostabilizers, and others.

Certain metallocenes exhibit a high degree of sensitivity to the hydrogen that is in the slurry polymerization reactors. This results in producing polypropylenes having a lower limit of MFR from 22 to 100 g/10 min or more. The polypropylenes in the present invention may be produced in a two-stage reactor system in one embodiment: a first and a second reactor, the first at a higher temperature than the second. By lowering the temperature of the two reactors used to produce the polypropylene, lower MFRs can be achieved. Table 1 shows this relationship for polypropylenes produced using the metallocene catalyst system, and more particularly using a metallocene selected from the group comprising dimethylsilandiylbis(2-methylindenyl)zirconium dichloride; dimethylsilandiylbis(2,4-dimethylindenyl)zirconium dichloride; dimethylsilandiylbis(2,5,6-trimethylindenyl)zirconium dichloride; dimethylsilandiylbis indenyl zirconium dichloride; dimethylsilandiylbis(4,5,6,7-tetrahydroindenyl)zirconium dichloride and dimethylsilandiylbis(2-methyl-4,5-benzoindenyl)zirconium dichloride; dimethylsilandiylbis(2-methyl-4-phenylindenyl)zirconium dichloride; dimethylsilandiylbis(2-methyl-4,6-diisopropylindenyl)zirconium dichloride; dimethylsilandiylbis(2-methyl-4-napthylindenyl)zirconium dichloride; and dimethylsilandiylbis(2-ethyl-4-phenylindenyl)zirconium dichloride.

TABLE 1
Relationship of Reactor Temperature and MFR

| First Reactor | Second Reactor | |
|---|---|---|
| Temperature (° C.) | Temperature (° C.) | MFR range (g/10 min) |
| 70 | 64 | 21-23 |
| 67 | 62 | 16-18 |
| 64 | 59 | 12-14 |

An example of one embodiment of the polypropylene formulation useful in the invention is a polypropylene synthesized using the metallocene catalyst system described above. The slurry polymerization process takes place in two stages, wherein the temperature of the first reactor is higher than the temperature of the second reactor, thus creating a temperature differential. In one embodiment, the temperature differential between the reactors if from 1° C. to 20° C., and from 2° C. to 15° C. in another embodiment, and in yet another embodiment the differential is from 3° C. to 10° C.

The reaction conditions during polymerization in one embodiment may be as follows: reactor temperatures to produce a finished product with a nominal 17.1 g/ 10 min MFR are 67.2° C. in the lead (first) reactor and 61.7° C. in the second reactor. In another embodiment, temperatures of 64.4° C. in the first reactor and 58.9° C. in the second reactor result in a finished product with a nominal MFR of about 13 g/10 min. In another embodiment of the invention, the polymerization takes place in two stages, the temperature of which is between 63° C. and 68° C. in a first reactor and between 58° C. and 62° C. in a second reactor. The metallocene used in the metallocene catalyst system is selected from the group comprising dimethylsilandiylbis(2-methylindenyl)zirconium dichloride; dimethylsilandiylbis(2,4-dimethylindenyl)zirconium dichloride; dimethylsilandiylbis(2,5,6-trimethylindenyl)zirconium dichloride; dimethylsilandiylbis indenyl zirconium dichloride; dimethylsilandiylbis(4,5,6,7-tetrahydroindenyl)zirconium dichloride and dimethylsilandiylbis(2-methyl-4,5-benzoindenyl)zirconium dichloride; dimethylsilandiylbis(2-methyl-4-phenylindenyl)zirconium dichloride; dimethylsilandiylbis(2-methyl-4,6-diisopropylindenyl)zirconium dichloride; dimethylsilandiylbis(2-methyl-4-napthylindenyl)zirconium dichloride; and dimethylsilandiylbis(2-ethyl-4-phenylindenyl)zirconium dichloride.

After polymerization, the polypropylene may be pelletized with the following additive package: DHT4A (Mg_{4.5}Al₂(OH)₁₃CO₃.3.5H₂0, Kiowa Chemical Industry Co., Ltd.) present at 0.01 wt % of the entire polymer/additive mixture, Irganox 1076 (octadecyl 3-(3′,5′-di-t-butyl-4′-hydroxyphenyl) propionate, CAS 2082-79-3, Ciba Specialty Chemicals) at 0.05%, Irgafos 168 (tris(2,4-di-t-butylphenyl) phosphite, (CAS 31570-04-4, Ciba Specialty Chemicals), and sodium benzoate present at 0.040 wt %. The homopolymer including the additive blend has an MFR 17.1 g/10 min in one example. The Mw value of this homopolymer was 162,619, and the Mn value was 96,889, resulting in a Mw/Mn value (MWD) of 1.68. The melting point of this homopolymer is 152.6° C., and the crystallization temperature is 121.9° C. The addition of the nucleating agent allows an a broader range of MFR to be achieved, while maintaining a high rate of crystallization which is desirable in injection molding applications and precision articles.

In one embodiment, the homopolymer and additive blend may have an MFR in the range from less than 100 g/10 min, and less than 35 g/10 min in another embodiment, and less than 21 g/10 min in yet another embodiment, and from 12 to 19 g/10 min in yet another embodiment, and from 13 to 17 g/10 min in yet another embodiment.

Desirably, the resultant polypropylene may have an MWD of from 1.5 to 2.5. The melting point is from 149° C. to 159° C., and in yet another embodiment from 151° C. to 154° C.; and the crystallization temperature is from 110° C. to 128° C. in one embodiment, from 119° C. to 126° C. in another embodiment, and from 120° C. to 123° C. in another embodiment. In yet another embodiment, the crystallization temperature is from 110° C. to 120° C., wherein the crystallization temperature range may be any combination of any maximum and any minimum value listed above.

Desirably, the polypropylenes of the present invention are highly isotactic. Thus, another feature of metallocene produced polymers useful in the present invention is the amount of amorphous polypropylene, or hexane extractables, they contain. The polypropylene of this invention may be characterized as having low amorphous polypropylene, less than 3% by weight in one embodiment, less than 2% by weight in another embodiment, and less than 1% by weight in yet another embodiment. In yet another embodiment, there is no measurable amorphous polypropylene.

There are many applications wherein a high degree of both accuracy and precision is desired in the polypropylene article. Such is the case in articles used for analytical measurements, manufacturing, and other precision uses. Embodiments of the polypropylene of the invention can be used in various high-precision articles. Examples of such articles are: contact lens casting cups, contact lens packages, micropipettes, centrifuge tubes, multi-well plates, diagnostic cuvettes, packaging for electronic data storage media including compact disks, DVDs, computer hard drives, etc, medical devices like syringes and auxiliary equipment, labware, devices manipulated by robotic equipment, and any device or article requiring accurate, precise, and stable dimensions.

The polypropylene described herein may be formed into articles by any of a variety of processes. Illustrative, but not limiting, examples of the forming methods, which may be employed, are injection molding, compression molding, thermoforming, injection blow molding, injection stretch blow molding, extrusion blow molding, and extrusion. For articles, the shapes of which permit, and which require a high degree of dimensional accuracy, precision, and stability like contact lens casting cups, the most preferred method of forming of the plastic is injection molding.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

We claim:

1. A precision injection molded article comprising isotactic polypropylene, the polypropylene having a MFR of less than 100 g/10 min, wherein the polypropylene also includes a nucleating agent.

2. The article of claim 1, wherein the polypropylene has a melting point of from 149° C. to 159° C.

3. The article of claim 1, wherein the polypropylene also has a crystallization temperature of from 110° C. to 126° C.

4. The article of claim 1, wherein the MWD value is from 1.5 to 2.5.

5. The article of claim 1, wherein polypropylene also includes a primary antioxidant, a secondary antioxidant and an acid scavenger.

6. The article of claim 1, wherein the nucleating agent is selected from the group consisting of sodium benzoate, sodium 2,2′-methylenebis(4,6-di-tert-butylphenyl) phosphate, aluminum 2,2′-methylenebis(4,6-di-tert-butylphenyl) phosphate, dibenzylidene sorbitol, di(p-tolylidene) sorbitol, di(p-ethylbenzylidene) sorbitol, bis(3,4-dimethylbenzylidene) sorbitol, and N′,N′-dicyclohexyl-2,6-naphthalenedicarboxamide, and salts of disproportionated rosin esters.

7. The article of Claim 1, wherein the polypropylene has a MFR of less than 35 g/10 min.

8. The article of claim 1, wherein the polypropylene has a MFR of less than 21 g/10 min.

9. The article of claim 1, wherein the MFR of the polypropylene is from 12 to 19 g/10 min.

10. A casting cup comprising isotactic polypropylene, the polypropylene having a MFR of less than 21 g/10 min and a Mw/Mn value of from 1.5 to 2.5.

11. The casting cup of claim 10, wherein the polypropylene has a melting point of from 149° C. to 159° C.

12. The casting cup of claim 10, wherein the polypropylene also has a crystallization temperature of from 110° C. to 126° C.

13. The casting cup of claim 10, wherein the MFR of the polypropylene is from 12 to 19 g/10 min.

14. The casting cup of claim 10, wherein the polypropylene also includes a nucleating agent.

15. The casting cup of claim 10, wherein polypropylene also includes a primary antioxidant, a secondary antioxidant and an acid scavenger.

16. A method of manufacturing a casting cup comprising polymerizing propylene in the presence of a metallocene catalyst system, wherein the resultant polypropylene has a MFR of less than 21 g/10 min.

17. The method of claim 16, wherein a nucleating agent is contacted with the resultant polypropylene.

18. The method of claim 17, wherein the nucleating agent is sodium benzoate.

19. The method of claim 18, wherein the sodium benzoate is present at 0.01 wt % relative to the total weight of the polymer and agent.

20. The method of claim 16, wherein the resultant polypropylene has a Mw/Mn value of from 1.5 to 2.5.

21. The method of claim 16, wherein the resultant polypropylene is combined with a primary antioxidant, a secondary antioxidant, and an acid scavenger.

22. The method of claim 21, wherein the primary antioxidant is Irganox 1076, the acid scavenger is DHT4A, and the secondary antioxidant is Irgafos 168.

23. The method of claim 16, wherein the polymerization takes place in two stages, the temperature of which is between 63° C. and 68° C. in a first stage and between 58° C. and 62° C. in a second stage.

24. The method of claim 16, wherein the polymerization takes place in two stages, and wherein there exists a temperature differential between the two stages of from 1° C. to 20° C.

25. A method of manufacturing high-precision articles comprising polymerizing propylene in the presence of a metallocene catalyst system, wherein the resultant polypropylene has a MFR of less than 21 g/10 min and a MWD of from 1.5 to 2.5.

26. The method of claim 25, wherein a nucleating agent is contacted with the resultant polypropylene.

27. The method of claim 26, wherein the nucleating agent is sodium benzoate.

28. The method of claim 27, wherein the sodium benzoate is present at 0.01 wt % relative to the total weight of the polymer and agent.

29. The method of claim 25, wherein the resultant polypropylene has a MWD value of from 1.5 to 2.5.

30. The method of claim 25, wherein the polymerization takes place in two stages, the first stage being at a higher temperature than a second stage.

31. The method of claim 26, wherein the first stage temperature is from 63° C. to 68° C., and the second stage temperature is from 58° C. to 62° C.

32. The method of claim 25, wherein the metallocene used in the metallocene system is selected from the group comprising the following: dimethylsilandiylbis(2-methylindenyl)zirconium dichloride; dimethylsilandiylbis(2,4-dimethylindenyl)zirconium dichloride; dimethylsilandiylbis(2,5,6-trimethylindenyl)zirconium dichloride; dimethylsilandiylbis indenyl zirconium dichloride; dimethylsilandiylbis(4,5,6,7-tetrahydroindenyl)zirconium dichloride and dimethylsilandiylbis(2-methyl-4,5-benzoindenyl)zirconium dichloride; dimethylsilandiylbis(2-methyl-4-phenylindenyl)zirconium dichloride; dimethylsilandiylbis(2-methyl-4,6-diisopropylindenyl)zirconium dichloride; dimethylsilandiylbis(2-methyl-4-napthylindenyl)zirconium dichloride; and dimethylsilandiylbis(2-ethyl-4-phenylindenyl)zirconium dichloride.

33. A high-precision polypropylene article comprising isotactic polypropylene, the polypropylene having a MFR less than 21 g/10 min and a MWD value of from 1.5 to 2.5, the polypropylene also comprising a nucleating agent.

34. The article of claim 33, wherein the nucleating agent is selected from the group consisting of sodium benzoate, sodium 2,2′-methylenebis(4,6-di-tert-butylphenyl) phosphate, aluminum 2,2′-methylenebis(4,6-di-tert-butylphenyl) phosphate, dibenzylidene sorbitol, di(p-tolylidene) sorbitol, di(p-ethylbenzylidene) sorbitol, bis(3,4-dimethylbenzylidene) sorbitol, and N′,N′-dicyclohexyl-2,6-naphthalenedicarboxamide, and salts of disproportionated rosin esters.

35. The article of claim 33, wherein the polypropylene also has a melting point of from 149° C. to 159° C.

36. The article of claim 33, wherein the polypropylene also has a crystallization temperature from 110° C. to 126° C.

37. The article of claim 33, wherein the polypropylene is isotactic, having a content of amorphous polymer of no more than 2 wt %.
